(19) United States
(12) Patent Application Publication
(10) Pub. No.: US 2002/0078900 A1
(43) Pub. Date: Jun. 27, 2002

(54) Nest clip

(76) Inventors: Don Van Gorp, Canehill, AR (US); Alfred E. Zaccanti JR., Fayetteville, AR (US)

Correspondence Address: Richard C. Litman, LITMAN LAW OFFICES, LTD., P.O. Box 15035, Arlington, VA, 22215, US

(21) Appl. No.: 09/748,155

(22) Filed: Dec. 27, 2000

(51) Int. Cl. A01K 31/14; A01K 45/00

(52) U.S. Cl. 119/329

(57) ABSTRACT

A plastic poultry nest cover that covers the entrance to a nesting bed. The protective cover has a flat middle portion, a hook shaped upper portion projecting to the front of the middle portion, and a flat, rearward sloping lower portion which supports the anterior portion of the wire mesh floor of the nesting bed. The plastic cover is preferably sunshine red in color, which attracts breeder hens to the nesting beds.

### BACKGROUND OF THE INVENTION

1. Field of the Invention

The present invention relates generally to poultry shelters and more particularly, to a plastic cover adapted for protecting the front panel portion of nesting beds of a poultry nest. Furthermore, the plastic cover serves to attract breeder hens to the nest.

2. Description of the Related Art

Increasing the service life of equipment and livestock structures on a farm is invaluable to a farmer because the profit margin in farming can vary substantially from year-to-year. Therefore, anything that assists the farmer economically is greatly appreciated. Livestock structures such as hen nests are routinely subjected to the elements, and to frequent and repeated use by the hens which cause the structures to deteriorate. Maintaining a hen nest in good condition increases egg production from the hens that use the hen nest and lowers the overall operating costs of the poultry farmer by significantly lowering repair costs.

The prior art describes a variety of structures used in the field of housing for breeder hens, for example, U.S. Pat. No. Des. 274,661, issued on Jul. 10, 1984 to T. Box, describes an ornamental design for a poultry breeder nest. An egg guard for poultry cages is described in U.S. Pat. No. 3,799,114, issued on Mar. 26, 1974 to R. J. Kenjesky. The one piece guard is positionable in a poultry cage and extends longitudinally across the cage and is perpendicular to the opposed end walls.

U.S. Pat. No. 4,188,911, issued on Feb. 19, 1980 to G. Rafaely, describes an enclosure device for encouraging the laying of eggs by domestic fowls particularly turkeys. The enclosure device consists of a cage open at opposite ends wherein one end constitutes the fowl-entry end for permitting the entry and exit of the domestic fowl, and the opposite end constitutes the egg-removal end for removing the egg laid by the fowl in the cage.

None of the above inventions and patents, taken either singularly or in combination, is seen to describe the instant invention as claimed. Thus a plastic poultry nest cover solving the aforementioned problems is desired.

### SUMMARY OF THE INVENTION

Accordingly, it is a principal object of the invention to provide a cover for the front panel of a poultry nest that prevents the front panels of the nesting beds from rusting.

It is another object of the invention to provide a cover for the front of a nesting bed that attracts breeder hens to nest.

It is a further object of the invention to provide a cover for the front of a nesting bed that stimulates breeder hens into increased production.

It is an object of the invention to provide improved elements and arrangements thereof for the purposes described which is inexpensive, dependable and fully effective in accomplishing its intended purposes.

To meet the above objectives, the present invention provides a plastic cover to protect the entrance to a hen nest. The plastic cover has a unique configuration or contour designed to protect the front panel portion of nesting beds from dirt and manure, and the distinctive “sunshine red” color of the plastic cover attracts breeder hens to the nest. Both the top and bottom portions of the metallic front panel of a hen's nest can rust as a result of exposure to moisture. If the bottom of the front panel has rusted out, the only option is to replace the entire front panel which is both costly and labor intensive.

The plastic cover of the present invention has a unitary construction including a flat panel with a generally inverted J-shaped clip at the top and a slanted ledge at the bottom, the clip and the ledge extending to opposite sides of the panel. The slanted ledge of the plastic cover supports the anterior portion of the wire mesh floor of a poultry nest.

In a first embodiment, an elongated plastic multi-nest panel cover is used to replace the conventional metal front panel of a multiple nest structure. The elongated plastic In this embodiment, it is possible to provide strong, durable, and weather resistant protection to the front of a several poultry nests using a single plastic cover.

In a second embodiment, a plastic single nest panel clip cover is used to protect the entrance of a single poultry nest. Ease of installation and removal is a cornerstone of this embodiment. Simply clip the plastic cover over the portion of the metallic front panel directly in front on a poultry nest and the entrance to the nest is protected.

By attracting breeder hens to the nest, the plastic cover of the present invention dramatically reduces the number of floor eggs which results in a greater number of clean eggs deposited in the nest. The plastic cover prevents the development of foot problems in breeder hens that result when the feet of a breeder hen comes into contact with the rusted top metal of the front panel of a poultry nest. The plastic cover also helps to hold the wire bottoms of the hen's nest in place because after an automatic nest is a few years old, the wire bottoms tend to fall out. The ⅛″ thickness of the plastic cover helps to hold the wire bottoms in place which results in a significant decrease in egg breakage.

The plastic cover of the present invention increases the longevity of a poultry nest and significantly reduces the cost of maintenance and repair. In addition, the plastic cover improves the health and the quality of life for the breeder hens by eliminating the potential for physical injury and illness caused by contact with rusting metal.

These and other objects of the present invention will become readily apparent upon further review of the following specification and drawings.

### BRIEF DESCRIPTION OF THE DRAWINGS

FIG. 1A is a fragmented perspective view of an elongated plastic multi-nest panel cover for a multiple nest structure for poultry according to the present invention.

FIG. 1B is a perspective view of a plastic single nest clip over cover for the entrance to a hen's nest.

FIG. 2 is a side view of the plastic cover.

FIG. 3 is an environmental front view of a plurality of plastic single nest clip covers covering the front panel of the nests in a multiple nest structure.

FIG. 4 is a bottom view of a multiple nest structure with an elongated plastic multi-nest panel cover.

FIG. 5 is a diagrammatic side view of a poultry nest showing a plastic single nest clip cover mounted on the front panel.

Similar reference characters denote corresponding features consistently throughout the attached drawings.

### DETAILED DESCRIPTION OF THE PREFERRED EMBODIMENTS

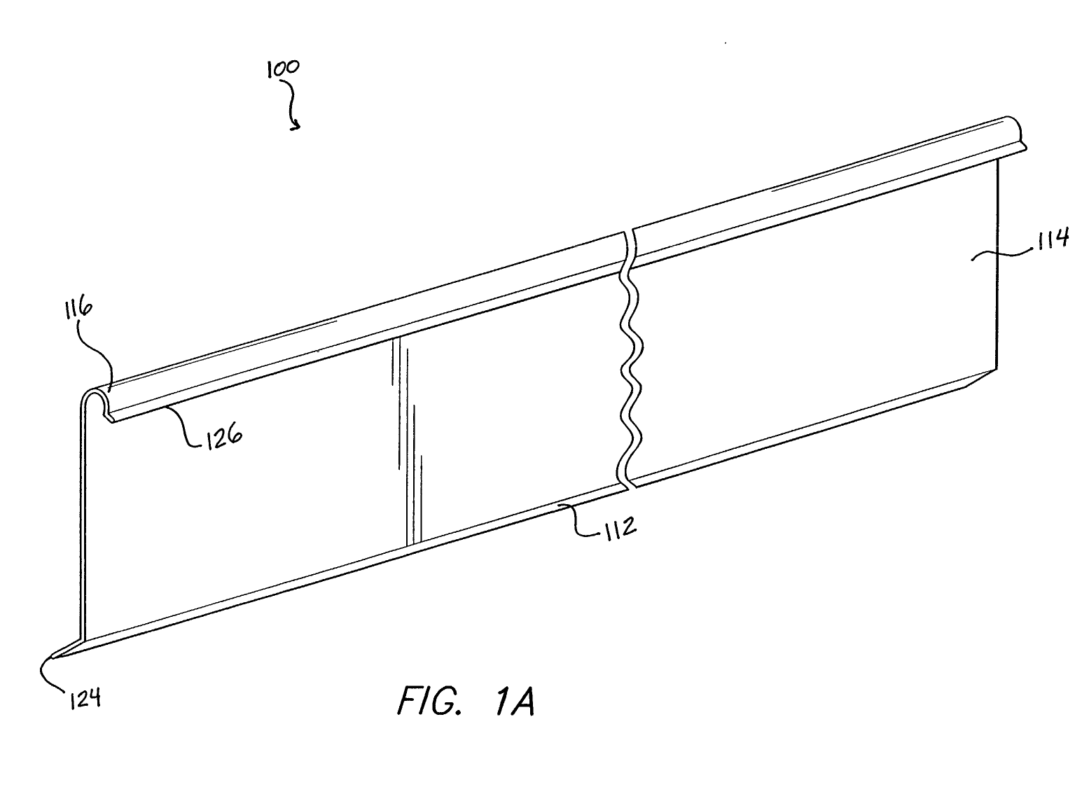

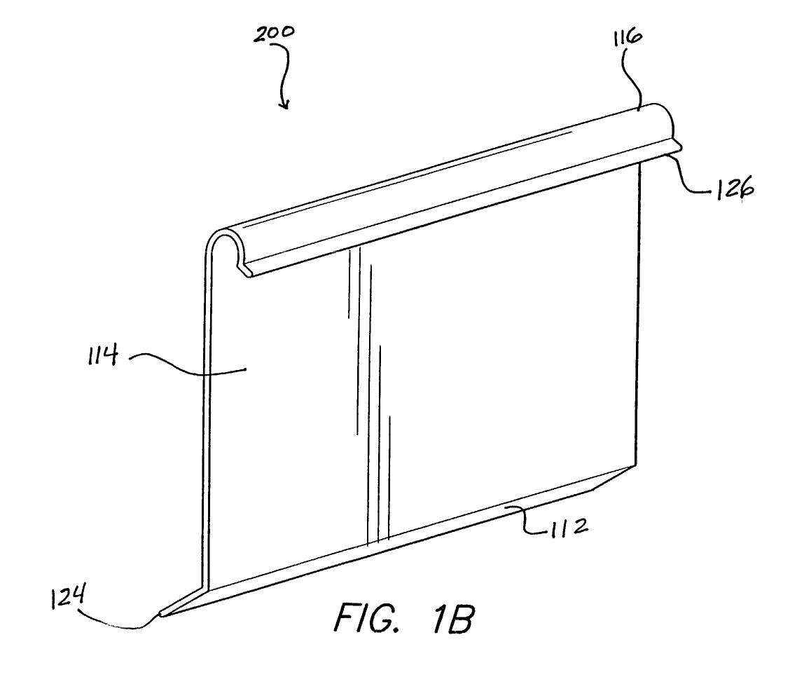

The present invention, as depicted in FIGS. 1-5, is a plastic cover 100,200 that covers the entrance 110 to a poultry nest 102. The distinctive appearance of the cover 100,200 results from an innovative configuration designed both to prevent the front panels 106 of nesting beds 104 from rusting and to attract breeder hens (not shown) to the nest 102. The cover 100,200 is configured and sized to provide maximum protection for the front panel 106 of the hen's nest 102 while at the same time providing maximum visual stimulation for the breeder hens. The single nest panel clip cover 200 shown in Fig. 1B protects the front panel of a nesting bed 102. In a preferred embodiment, the cover 100,200 is made of plastic, however, any suitable material can be used, and the color of the cover 100,200 is preferably “sunshine red,” however, the cover 100,200 could be painted any suitable color, for example, yellow. It is known that the color red attracts hens and will draw the hens from the floor of the hen house to the nest, thereby reducing the problems caused by eggs laid on the floor of the hen house.

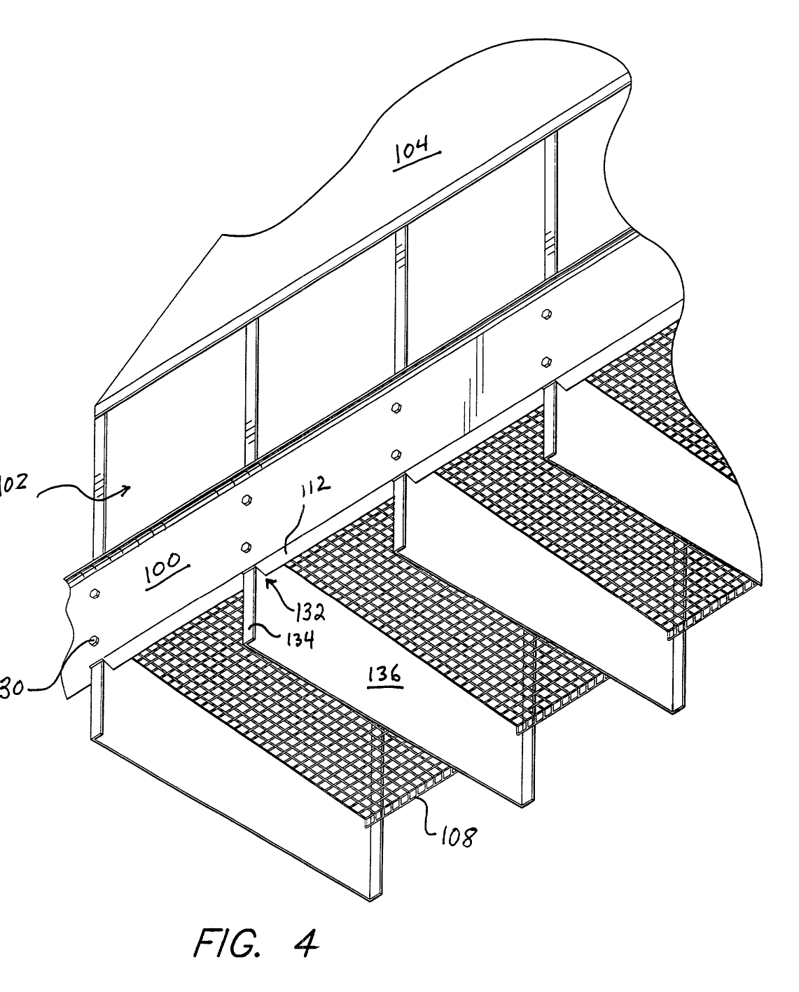

FIG. 1A is a perspective view of a first embodiment of the plastic cover 100 used to cover the fronts of multiple poultry nests 102 of a multiple poultry nest structure 104 as shown in FIG. 4. FIG. 1A, 1B, and 2 show the distinctive contour of the plastic cover 100,200. The cover 100,200 has a unitary one-piece construction. The lower portion 112 of the cover 100,200 is a flat, inclined or sloped ledge while the upper portion 116 is a curved hook. The middle or flat panel portion 114 of the cover 100,200 has a straight, flat, rectangular shape.

The embodiment depicted in FIG. 1A shows an elongated multi-nest plastic panel cover 100 that is used to cover the entrances 110 of multiple poultry nests 102 instead of the conventional metal front panel 106. The multi-nest panel cover 100 may be used to replace the front panel 106 of a multiple nest structure when the front panel 106 and bottom of the nests has rusted out and requires replacement. Rust is a two-fold problem, weakening the structure and causing breeder hens to develop foot ailments, such as staphylococcus infections. The elongated cover 100 has a height of 5 inches, a length of about 60 inches, and a thickness in the range of 1/16 to ⅛ inches. The embodiment depicted in FIG. 1B shows a single nest plastic panel clip cover 200 that is used to cover the entrance 110 of an individual nesting bed 102 in a multiple nesting bed structure by clipping over the metal front panel portion 106 of the hen's nest 102. The clip cover 200 has a height of 5 inches, a length of 8 inches, and a thickness in the range of 1/16 to ⅛ inches.

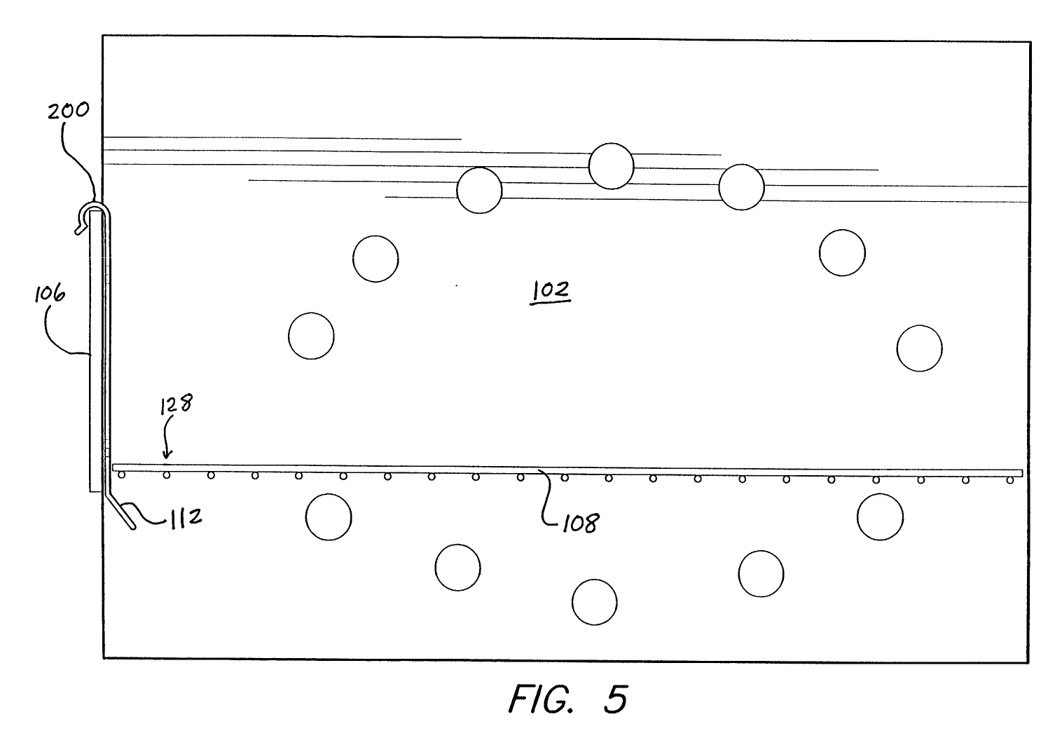

The curved hook portion 116 extends outward to the front of the plane of the middle panel portion 114, the distance from the straight middle portion 114 of the cover 100 to the point of maximum curvature of the curved upper portion 116 of the cover 100 is about three-quarters of an inch. The hook portion 116 and the panel portion 114 resemble an inverted “J”, the shorter leg 122 of the J having the shape of a circular arc and terminating in a flat lip 126 which slopes away from the mouth of the J, forming an obtuse angle with the shorter leg 122 of the J, the hook portion 116 defining a clip. The lower ledge portion 112 of the cover 100 projects downward and rearward from the middle panel portion 114, the distance from the edge 124 of the inclined lower portion 112 of the cover 100 to the junction with the straight panel portion 114 of the cover 100 is also three-quarters of an inch. The rounded hook portion 116 provides a hen with a comfortable place to perch before entering the poultry nest 102. The inclined lower ledge portion 112 of the cover 100 is designed to support the anterior portion 128 of wire mesh floor 108 of the hen's nest 102, as shown in FIG. 5.

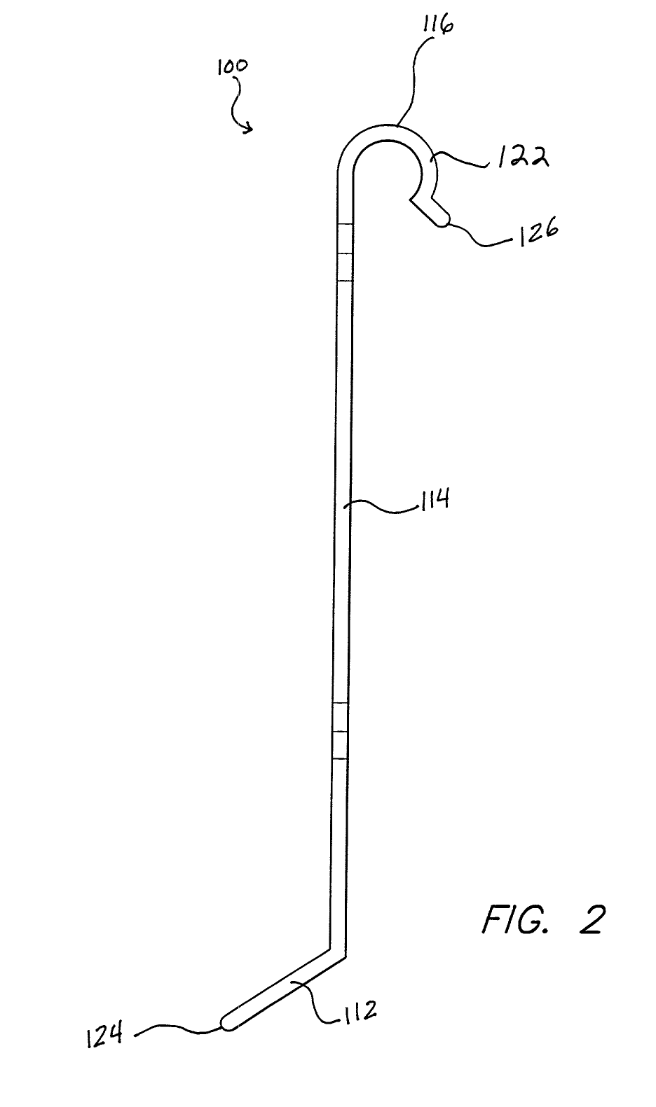

FIG. 2 is a side view of the plastic cover 100,200 which further illustrates the unique configuration of the cover 100,200. The inclined lower portion 112 of the cover 100,200 extends the cover 100,200 inward to support the anterior portion 128 of wire mesh floor 108 of the hen's nest 102 as depicted in FIG. 5. The curved upper portion 116 of the cover 100,200 has a hook shape or appearance when viewed from the side as depicted in FIG. 2.

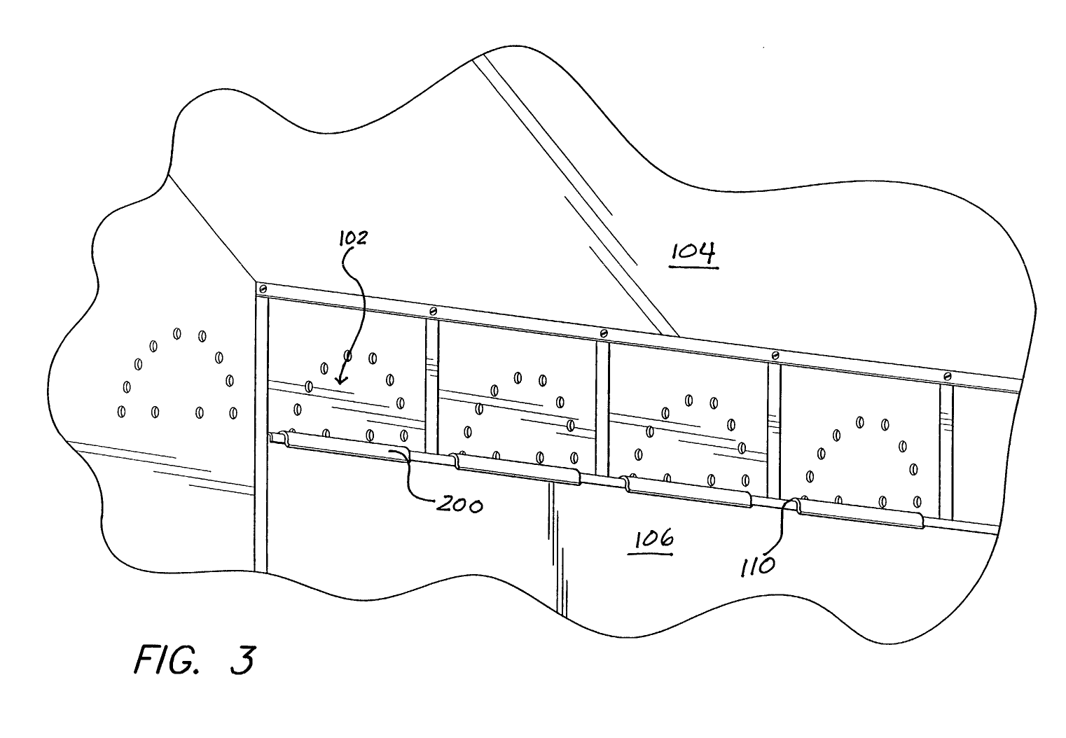

FIG. 3 is an environmental, front view of a multiple nest structure 104 with plastic single nest panel clip covers 200 covering the entrances 110 of the individual nests 102. FIG. 4 is a bottom view of a multiple nest structure 104 with an elongated plastic panel cover 100 replacing the metallic front panel 106 of the multiple nest structure 104. Bolts or screws 130 are used to secure the elongated plastic panel cover 100 to the multiple nest structure 104 as depicted in FIG. 4. Notches 132 defined in the ledge 112 accommodate front flanges 134 on the walls 136 of the individual nests 102. The tough and durable elongated plastic panel cover 100 can withstand the rigors of inclement and hostile weather, and the rigors of continuous and sustained use.

FIG. 5 is a diagrammatic end view of a hen's nest 102 showing a plastic clip over cover 200 mounted over the front panel portion 106 of the poultry nest 102. FIG. 5 shows how the lower inclined portion 112 of the plastic clip over cover 200 supports the anterior portion 128 of the wire mesh floor 108 of the poultry nest 102.

The plastic cover 100, 200 of the present invention is preferably made from polyethylene, polypropylene, vinyl, or other thermoplastic material. The cover 100, 200 may be made inexpensively by any conventional plastic forming process, such as extrusion, injection molding, etc. Advantageously, the plastic material is corrosion resistant, reducing or eliminating the problem of rusting in conventional hen house nests.

The novel and innovative plastic covers of the present invention serve multiple functions which collectively result in increased egg production by the breeder hens, substantially improved overall health of the breeder hens, and increased service life for the hen house. The elongated multi-nest plastic cover provides protection for multiple poultry nests using a single cover while the plastic single-nest clip cover provides protection for individual poultry nests that is quick and easy to install and replace.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated. It is to be understood that the present invention is not limited to the embodiments described above, but encompasses any and all embodiments within the scope of the following claims.

We claim:

1. A single nest panel clip cover for a poultry nest, comprising a configured cover having a one-piece, unitary construction, said cover having:
a curved, hook shaped upper portion defining a clip for attachment to the front panel of a hen house nest;
a straight, flat, rectangular shaped middle panel portion having a front surface and a rear surface, the curved upper portion extending frontward from the middle portion; and
a flat lower ledge portion sloping downward and rearward from the middle portion, the flat lower portion having an edge adapted for supporting a portion of the floor of a poultry nest.

2. A single nest panel clip cover according to claim 1, wherein said cover is made of plastic.

3. A single nest panel clip cover according to claim 1, wherein said cover is red.

4. A single nest panel clip cover according to claim 1, wherein said cover has a height of about five inches, a length of about eight inches, and a thickness in the range of 1/16 to ⅛ inches.

5. A single nest panel clip cover according to claim 1, wherein the upper hook shaped portion of said cover is sized and dimensioned for clipping over a top edge of a metallic front panel of a hen's nest.

6. An elongated multi-nest panel cover for a multiple nest structure for poultry, comprising an elongated configured cover having a one-piece, unitary construction, said cover having:
a curved, hook shaped upper portion;
a straight, flat, rectangular shaped middle panel portion having a front surface and a rear surface, the curved upper portion extending frontward from the middle portion; and
a flat lower ledge portion sloping downward and rearward from the middle portion, the flat lower portion having an edge adapted for supporting a portion of the floors of multiple hen nests.

7. An elongated multi-nest panel cover according to claim 6, wherein said cover is made of plastic.

8. An elongated multi-nest panel cover according to claim 6, wherein said cover is red.

9. An elongated multi-nest panel cover according to claim 6, wherein said cover has a height of about five inches, a length of about sixty inches, and a thickness in the range of 1/16 to ⅛ inches.

10. An elongated multi-nest panel cover according to claim 6, wherein said cover is sized and dimensioned for replacing a metallic front panel of a multiple nest structure.

11. An elongated multi-nest panel cover according to claim 6, wherein said cover is adapted for attachment to a multiple nest structure by screws.

12. A plastic cover for attachment to a hen house nest, comprising a one-piece cover having:
a) a flat, rectangular panel forming a middle portion of said cover and having a front and a rear;
b) a hook shaped clip forming an upper portion of said cover, the clip extending to the front of said panel;
c) a flat ledge forming a lower portion of said cover, the ledge sloping downward and rearward from said panel, the ledge being adapted for supporting a wire floor of a hen's nest; and
d) wherein said cover is made in one-piece from a thermoplastic material.

13. The plastic cover according to claim 12, wherein said cover is red in color in order to attract a hen to a hen's nest.

14. The plastic cover according to claim 12, wherein the hook shaped upper portion of said cover is adapted for clipping onto a top edge of a front cover of a hen's nest.

15. The plastic cover according to claim 12, wherein said cover has a height of about five inches, a length of about eight inches, and a thickness in the range of 1/16 to ⅛ inches, the length of said cover being sized and dimensioned for clipping over a top edge of a front panel of a single nest of a multi-nest hen house nesting structure.

16. The plastic cover according to claim 12, wherein said cover has a height of about five inches, a length of about sixty inches, and a thickness in the range of 1/16 to ⅛ inches, the length of said cover being sized and dimensioned for replacing a front panel of a single nest of a multi-nest hen house nesting structure.

17. The plastic cover according to claim 12, wherein said ledge has a plurality of notches defined therein, each notch being sized and dimensioned for receiving a flange on a wall of a nest in a multi-nest hen house nesting structure, whereby said cover may be closely approximated to a front of the nesting structure in order to form a front panel of the nesting structure.
